(19) United States
(12) Patent Application Publication
(10) Pub. No.: US 2021/0318667 A1
(43) Pub. Date: Oct. 14, 2021

(54) SYSTEMS AND METHODS FOR DAMPING TEMPERATURE PEAKS WITH MOISTURE-SORBING HEATSINKS

(71) Applicant: Dell Products L.P., Round Rock, TX (US)

(72) Inventors: Steven EMBLETON, Austin, TX (US); Sandor FARKAS, Round Rock, TX (US); Eric M. TUNKS, Austin, TX (US)

(73) Assignee: Dell Products L.P., Round Rock, TX (US)

(21) Appl. No.: 16/846,753

(22) Filed: Apr. 13, 2020

(51) Int. Cl. G05B 19/406

(52) U.S. Cl. CPC G05B 19/406; G05B 2219/49216

(57) ABSTRACT

An information handling system may include an information handling resource, an air mover configured to drive a flow of air, and heat-rejecting media thermally coupled to the information handling resource, the heat rejecting media comprising a heatsink structure, the heatsink structure comprising a plurality of heatsink features, wherein a portion of the heatsink features are coated with a desiccant material.

### TECHNICAL FIELD

The present disclosure relates in general to information handling systems, and more particularly to cooling of information handling system components using heat-rejecting media, including moisture-sorbing heatsinks.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As processors, graphics cards, random access memory (RAM) and other components in information handling systems have increased in clock speed and power consumption, the amount of heat produced by such components as a side-effect of normal operation has also increased. Often, the temperatures of these components need to be kept within a reasonable range to prevent overheating, instability, malfunction and damage leading to a shortened component lifespan. Accordingly, air movers (e.g., cooling fans and blowers) have often been used in information handling systems to cool information handling systems and their components.

To control temperature of components of an information handling system, an air mover may direct air over one or more heatsinks thermally coupled to individual components.

Generally, an information handling system and its components are designed to be cooled sufficiently when operating at maximum power and while under given worst-case environmental conditions. Thermal control of an information handling system is also often designed such that during low component power, air mover speeds are reduced to prevent overcooling. One problem is that during power spikes, the temperature of a component may rise too fast for the closed loop thermal control of the information handling system to increase fan speed before the component exceeds its temperature specifications and starts throttling, thus leading to decreased performance.

### SUMMARY

In accordance with the teachings of the present disclosure, the disadvantages and problems associated with traditional approaches to cooling information handling system components may be substantially reduced or eliminated.

In accordance with embodiments of the present disclosure, an information handling system may include an information handling resource, an air mover configured to drive a flow of air, and heat-rejecting media thermally coupled to the information handling resource, the heat rejecting media comprising a heatsink structure, the heatsink structure comprising a plurality of heatsink features, wherein a portion of the heatsink features are coated with a desiccant material.

In accordance with these and other embodiments of the present disclosure, heat-rejecting media may comprise a heatsink structure, wherein the heatsink structure may include a plurality of heatsink features and desiccant material configured such that a portion of the heatsink features are coated with the desiccant material.

In accordance with these and other embodiments of the present disclosure, a method for fabricating heat-rejecting media may include providing a plurality of heatsink structures and coating the plurality of heatsink structures in desiccant material configured such that a portion of the heatsink features are coated with the desiccant material.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a perspective view of a moisture-sorbing heatsink, in accordance with embodiments of the present disclosure.

### DETAILED DESCRIPTION

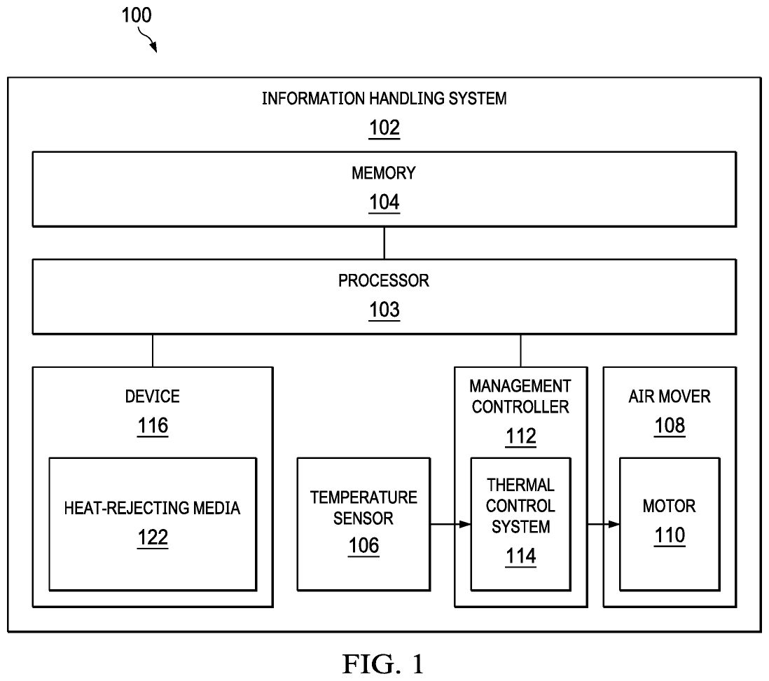

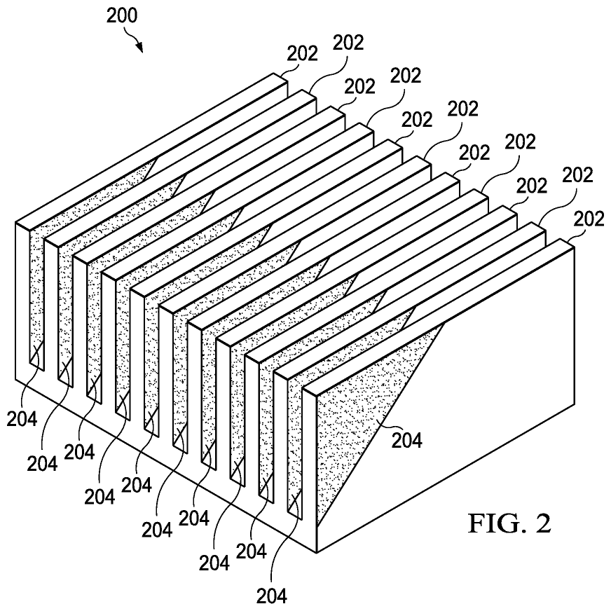

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data. As shown in FIG. 1, information handling system 102 may include a chassis 100 housing a processor 103, a memory 104, a temperature sensor 106, an air mover 108, a management controller 112, a device 116, and heat-rejecting media 122.

Processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

Air mover 108 may include any mechanical or electro-mechanical system, apparatus, or device operable to move air and/or other gases in order to cool information handling resources of information handling system 102. In some embodiments, air mover 108 may comprise a fan (e.g., a rotating arrangement of vanes or blades which act on the air). In other embodiments, air mover 108 may comprise a blower (e.g., a centrifugal fan that employs rotating impellers to accelerate air received at its intake and change the direction of the airflow). In these and other embodiments, rotating and other moving components of air mover 108 may be driven by a motor 110. The rotational speed of motor 110 may be controlled by an air mover control signal communicated from thermal control system 114 of management controller 112. In operation, air mover 108 may cool information handling resources of information handling system 102 by drawing cool air into an enclosure housing the information handling resources from outside the chassis, expelling warm air from inside the enclosure to the outside of such enclosure, and/or moving air across one or more heat sinks (not explicitly shown) internal to the enclosure to cool one or more information handling resources.

Management controller 112 may comprise any system, device, or apparatus configured to facilitate management and/or control of information handling system 102 and/or one or more of its component information handling resources. Management controller 112 may be configured to issue commands and/or other signals to manage and/or control information handling system 102 and/or its information handling resources. Management controller 112 may comprise a microprocessor, microcontroller, DSP, ASIC, field programmable gate array (“FPGA”), EEPROM, or any combination thereof. Management controller 112 also may be configured to provide out-of-band management facilities for management of information handling system 102. Such management may be made by management controller 112 even if information handling system 102 is powered off or powered to a standby state. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

As shown in FIG. 1, management controller 112 may include a thermal control system 114. Thermal control system 114 may include any system, device, or apparatus configured to receive one or more signals indicative of one or more temperatures within information handling system 102 (e.g., one or more signals from one or more temperature sensors 106), and based on such signals, calculate an air mover driving signal to maintain an appropriate level of cooling, increase cooling, or decrease cooling, as appropriate, and communicate such air mover driving signal to air mover 108. In these and other embodiments, thermal control system 114 may be configured to receive information from other information handling resources and calculate the air mover driving signal based on such received information in addition to temperature information. For example, as described in greater detail below, thermal control system 114 may receive configuration data from device 116 and/or other information handling resources of information handling system 102, which may include thermal requirements information of one or more information handling resources. In addition to temperature information collected from sensors within information handling system 102, thermal control system 114 may also calculate the air mover driving signal based on such information received from information handling resources.

Temperature sensor 106 may be any system, device, or apparatus (e.g., a thermometer, thermistor, etc.) configured to communicate a signal to management controller 112 or another controller indicative of a temperature within information handling system 102. In many embodiments, information handling system 102 may comprise a plurality of temperature sensors 106, wherein each temperature sensor 106 detects a temperature of a particular component and/or location within information handling system 102.

Device 116 may comprise any component information handling system of information handling system 102, including without limitation processors, buses, memories, I/O devices and/or interfaces, storage resources, network interfaces, motherboards, integrated circuit packages; electro-mechanical devices, displays, and power supplies.

As shown in FIG. 1, device 116 may have mechanically and thermally coupled thereto heat-rejecting media 122. Heat-rejecting media 122 may include any system, device, or apparatus configured to transfer heat from an information handling resource (e.g., device 116, as shown in FIG. 1), thus reducing a temperature of the information handling resource. For example, heat-rejecting media 122 may include a solid thermally coupled to the information handling resource (e.g., heatpipe, heat spreader, heatsink, finstack, etc.) such that heat generated by the information handling resource is transferred from the information handling resource into air surrounding the information handling resource. For example, in the embodiments represented by FIG. 1, heat-rejecting media 122 may be thermally coupled to device 116 and arranged such that heat generated by device 116 is transferred to air driven by air mover 108. In particular embodiments, heat-rejecting media 122 may comprise a moisture-sorbing heatsink, such as that depicted in FIG. 2 and described below.

In addition to processor 103, memory 104, temperature sensor 106, air mover 108, management controller 112, device 116, and heat-rejecting media 122, information handling system 102 may include one or more other information handling resources. In addition, for the sake of clarity and exposition of the present disclosure, FIG. 1 depicts only one air mover 108 and one device 116. In embodiments of the present disclosure, information handling system 102 may include any number of air movers 108 and devices 116. However, in some embodiments, approaches similar or identical to those used to cool device 116 as described herein may be employed to provide cooling of processor 103, memory 104, management controller 112, and/or any other information handling resource of information handling system 102.

FIG. 2 illustrates a perspective view of a moisture-sorbing heatsink 200, in accordance with embodiments of the present disclosure. In some embodiments, heatsink 200 may implement all or a portion of heat-rejecting media 122 depicted in FIG. 1. Heatsink 200 may include any system, device, or apparatus configured to transfer heat from an information handling resource (e.g., device 116), thus reducing a temperature of the information handling resource.

As shown in FIG. 2, heatsink 200 may include a plurality of generally parallel fins 202 which may be generally parallel with a direction of airflow (e.g., a direction of airflow from air driven by air mover 108). Thus, air driven by air mover 108 may pass over the surfaces of fins 202 of heatsink 200, thus cooling heatsink 200 and in turn cooling an information handling resource to which heatsink 200 is thermally coupled.

Although FIG. 2 depicts heatsink 200 as having a plurality of generally parallel fins 202, in some embodiments, heatsink 200 may include a row of a plurality of “pins fins” in lieu of a fin 202. Other configurations, shapes, sizes, and dimensions of heatsink features may also used consistent with this disclosure.

As shown in FIG. 2, each fin 202 (or another feature) may have a portion coated with desiccant material 204. For example, in some embodiments, heatsink 200 may be most efficient at the “front” where cool air driven by air mover 108 first meets the fins 202. In such embodiments, at the “rear” of heatsink 200, the air may be warmer and thus efficiency of the heatsink 200 in such region may be significantly degraded. Accordingly, in such embodiments, features (e.g., fins 202) in the rear region may be coated (e.g., in a thin layer) with moisture-sorbing desiccant material 204. For example, each feature (e.g., fin 202) may be configured such that the surface area of the feature 202 coated in desiccant material 204 increases as distance from air mover 108 increases. In a particular example, as shown in FIG. 2, a corner of the surface area of each feature (e.g., fin) may be coated in desiccant material. Thus, stated another way, heatsink 200 may include heatsink features (e.g., fins 202) wherein the heatsink features are coated with desiccant material 204 such that a percentage of the surface area of heatsink 200 coated with desiccant material 204 increases from a first end (closer to air mover 108) of heatsink 200 to a second end (further from air mover 108) of heatsink 200. However, it is noted that the particular locations of heatsink 200 shown as coated with desiccant material 204 in FIG. 2 and the example embodiments of this paragraph are non-limiting. Other embodiments in accordance with this disclosure may vary in shapes and/or area of the application of desiccant material 204 on heatsink. Shapes and/or area of portions of heatsink coated in desiccant material 204 may vary from embodiment to embodiment based on desiccant efficiency, general convective performance of a cooling system, and/or other factors.

Thus, in operation of information handling system 102 and thermal control system 114, portions of heatsink 200 coated in desiccant material 204 may capture and release moisture depending on a thermal state of heatsink 200. For example, when an information handling resource to which heatsink 200 is thermally coupled is idle, desiccant material 204 may absorb moisture. However, as the information handling resource heats up, in turn heating heatsink 200, moisture may evaporate from desiccant material 204, thus assisting in cooling of heatsink 200. Such moisture-evaporative cooling may be most profound, and also most useful, during temperature spikes of the information handling resource before closed-loop thermal control system 114 has time to adjust to increased temperature. Accordingly, moisture-sorbing heatsink 200 may provide a mechanism that enables damping of temperature spikes over a small time period (e.g., a period of time required to evaporate the moisture captured by desiccant material 204). Such damping may allow information handling system 102 and its information handling resources to experience rapid power increases without needing to throttle the performance for thermal reasons.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
an information handling resource;
an air mover configured to drive a flow of air; and
heat-rejecting media thermally coupled to the information handling resource, the heat rejecting media comprising a heatsink structure, the heatsink structure comprising a plurality of heatsink features, wherein a portion of the heatsink features are coated with a desiccant material.

2. The information handling system of claim 1, wherein the portion of the heatsink features are coated with a desiccant material such that a percentage of surface area of the heatsink structure coated with the desiccant material increases from a first end of the heatsink structure to a second end of the heatsink structure located further from the air mover than the first end.

3. The information handling system of claim 1, wherein the plurality of heatsink features comprises a plurality of generally parallel fins configured generally parallel to the flow of air.

4. The information handling system of claim 1, further comprising:
a temperature sensor; and
a closed-loop thermal control system for controlling the flow of air driven by the air mover based on a temperature sensed by the temperature sensor.

5. Heat-rejecting media comprising a heatsink structure, the heatsink structure comprising:
a plurality of heatsink features; and
desiccant material configured such that a portion of the heatsink features are coated with the desiccant material.

6. The heat-rejecting media of claim 5, wherein the heatsink features are coated with the desiccant material such that a percentage of surface area of the heatsink structure coated with the desiccant material increases from a first end of the heatsink structure to a second end of the heatsink structure.

7. The heat-rejecting media of claim 5, wherein the plurality of heatsink features comprises a plurality of generally parallel fins configured generally parallel to the flow of air.

8. A method for fabricating heat-rejecting media comprising:
providing a plurality of heatsink structures; and
coating the plurality of heatsink structures in desiccant material configured such that a portion of the heatsink features are coated with the desiccant material.

9. The method of claim 8, wherein coating comprising coating such that a percentage of surface area of the heatsink structure coated with the desiccant material increases from a first end of the heatsink structure to a second end of the heatsink structure.

10. The method of claim 8, wherein the plurality of heatsink features comprises a plurality of generally parallel fins configured generally parallel to the flow of air.
